(19) United States
(12) Patent Application Publication
(10) Pub. No.: US 2026/0285714 A1
(43) Pub. Date: Sep. 24, 2026

(54) SYSTEM AND METHOD FOR ON-SITE GENERATION OF CHLORINE-BASED DISINFECTANT

(71) Applicants: Craig Peter Cunningham, Kennebunk, ME (US); Craig Justin Lakin, Portland, ME (US)

(72) Inventors: Craig Peter Cunningham, Kennebunk, ME (US); Craig Justin Lakin, Portland, ME (US)

(21) Appl. No.: 19/570,260

(22) Filed: Mar. 18, 2026

Related U.S. Application Data
(60) Provisional application No. 63/774,419, filed on Mar. 19, 2025.

(51) Int. Cl. C02F 1/461

(52) U.S. Cl. CPC C02F 1/46109; C02F 2201/004; C02F 2201/007; C02F 2201/4614; C02F 2201/46145

(57) ABSTRACT

A system and method are disclosed for on-site generation of chlorine-based disinfectant in chloride-containing water streams, including wastewater effluent, to reduce reliance on bulk storage and handling of chlorine-containing chemicals.

### BACKGROUND INFORMATION

### Field of the Invention

The invention relates generally to electrochemical generation of chlorine-based disinfectants, and more particularly to membrane-less electrolysis reactors configured for on-site production of hypochlorous acid and chlorine species from chloride-containing water streams, including wastewater effluent.

### Discussion of Prior Art

Wastewater treatment is a process used to remove contaminants from wastewater so that the treated effluent may be safely returned to the natural water cycle. The process, sometimes referred to as water reclamation, is commonly performed in municipal and industrial wastewater treatment facilities.

In a typical municipal wastewater treatment plant, sewage is conveyed through a network of pipes and pump stations to a centralized treatment facility. At the treatment facility, the wastewater typically undergoes a sequence of treatment stages designed to remove solids, organic matter, and pathogens prior to discharge. Initial treatment stages may include screening operations to remove large debris such as wood, plastics, and rocks. The screened wastewater may then undergo aeration and biological treatment processes that promote microbial degradation of organic material. Subsequent clarification stages permit heavier particles to settle out of the water column while lighter materials such as oils and grease are separated and removed.

Following these primary and secondary treatment stages, a disinfection step is typically performed to reduce or eliminate pathogenic microorganisms prior to discharge of the treated effluent into rivers, lakes, or oceans. Chlorine-based disinfectants are widely used for this purpose due to their effectiveness and relatively low cost.

Traditionally, wastewater treatment facilities have relied on bulk storage of chlorine-containing chemicals, such as chlorine gas or concentrated sodium hypochlorite (bleach), which are transported to the treatment facility and stored on site for later dosing into the effluent stream. However, the transportation, storage, and handling of these chemicals present several challenges. Chlorine gas is highly toxic and requires specialized containment systems and safety protocols. Concentrated sodium hypochlorite solutions degrade over time and may present hazards associated with storage, chemical handling, and transportation. Additionally, the use of bulk chlorine solutions can introduce operational costs related to procurement, storage infrastructure, and regulatory compliance.

In an effort to address these concerns, on-site electrochemical chlorine generation systems have been developed. In such systems, an electric current is passed through a brine solution containing sodium chloride to produce chlorine species that may be used for disinfection. Many existing electrochemical chlorine generation systems employ membrane-based electrolysis cells or complex multi-chamber reactors designed to separate reaction products. While such systems may be effective, they can be relatively expensive to construct and maintain, and often require highly purified brine feedstocks to prevent membrane fouling or degradation.

Other electrochlorination systems generate chlorine by electrolyzing brine solutions using electrode assemblies within a flow cell. However, many known designs rely on relatively complex reactor geometries, specialized materials, or multiple electrochemical cells connected in series. These systems may require substantial capital investment, maintenance, or operating complexity, particularly when implemented in smaller wastewater treatment facilities.

Accordingly, there remains a need for improved systems and methods capable of generating chlorine-based disinfectants on site in a manner that reduces cost, complexity, and safety risks associated with conventional chlorine storage and delivery systems. In particular, there is a need for electrochemical chlorine generation systems that are capable of operating directly with wastewater effluent streams, that do not require complex membrane assemblies, and that can be readily integrated into existing wastewater treatment infrastructure.

What is needed, therefore, is a method of obtaining the benefits of a chlorine application without the costs and hazards of using an actual chlorine solution.

### BRIEF SUMMARY OF THE INVENTION

The present invention relates to systems and methods for generating chlorine-based disinfectants on site, and more particularly to a modular electrolysis reactor system configured to produce chlorine species, including chlorine and hypochlorous acid, from chloride-containing water streams such as wastewater effluent.

In one aspect, the invention provides a membrane-less electrolysis reactor configured for flow-through operation. The reactor includes a cathode structure having a plurality of openings extending through the cathode body and one or more anodes positioned within each of the openings. The anodes are spaced from inner surfaces of the openings in the cathode to define electrolysis regions through which a chloride-containing liquid flows. When an electrical potential is applied between the cathode and the anodes, chloride ions present in the liquid are oxidized at the anodes to produce chlorine species, while hydrogen is generated at the cathode.

In another aspect, the invention provides a modular disinfectant generation system that includes one or more of the electrolysis reactors arranged in parallel within a production cabinet. The reactors are connected to receive a flow of wastewater effluent and a source of sodium chloride or other chloride-containing material. A power supply provides electrical current to the reactors to drive electrolysis reactions that generate chlorine-based disinfectants directly within the flowing water stream. The modular configuration allows the disinfectant generation capacity of the system to be scaled by increasing or decreasing the number of reactors installed within the production cabinet.

In another aspect, the invention provides a method for disinfecting wastewater effluent in a wastewater treatment facility. The method includes directing a stream of wastewater effluent containing dissolved sodium chloride through one or more flow-through electrolysis reactors, applying an electrical potential between anodes and a cathode within the reactor to oxidize chloride ions and generate chlorine species, and allowing the generated chlorine species to disinfect the wastewater prior to discharge into the environment.

In certain embodiments, the electrolysis reactor is configured as a tubular flow-through reactor in which wastewater flows between the cathode and the anodes, thereby serving as the electrolyte for the electrochemical reaction. The reactor may operate without an ion exchange membrane, thereby simplifying construction and reducing maintenance requirements relative to membrane-based electrolysis systems.

In some embodiments, the cathode comprises a conductive disk having multiple through-holes, and the anodes comprise elongated conductive rods positioned within the through-holes. The spacing between the anodes and the cathode surfaces may be selected to reduce electrical resistance and improve current efficiency. In certain embodiments, multiple anodes may be positioned within a single opening in the cathode to increase active surface area and reduce electrode spacing, thereby improving reactor performance.

The system is configured to replace or reduce the use of stored chlorine or concentrated sodium hypochlorite solutions commonly used for wastewater disinfection. By generating chlorine-based disinfectants on demand from sodium chloride and wastewater effluent, the system can reduce the risks, costs, and logistical challenges associated with the transportation, storage, and handling of bulk chlorine chemicals.

The modular electrolysis reactors described herein may be incorporated into existing wastewater treatment infrastructure and operated as part of a final disinfection stage of the treatment process. The reactors may be installed in parallel configurations and controlled through an electrical control system that regulates current supplied to the reactors based on operational conditions such as wastewater flow rate or desired disinfectant production.

These and other aspects, features, and advantages of the invention will become apparent from the following detailed description and the accompanying drawings.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a front view of a production cabinet having a number of reactors according to the invention.

FIG. 2 is a plan view of the reactors and connective tubing without the cabinet.

FIG. 3 is a plan view of a single reactor.

FIG. 4 is an exploded view of the reactor.

FIG. 5 is a cross-sectional view of the reactor showing the cathode and anodes.

FIG. 6 is a side view of segment of the reactor.

FIG. 7 is a front view of a control cabinet.

FIG. 8 is an example diagram of a wastewater treatment facility.

FIG. 9 is an illustration of the electrolysis reaction used to produce chlorine.

FIG. 10 is a chart that illustrates current efficiency to current density.

FIG. 11 is a chart that illustrates chlorine production rate by current density.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

In general, the system 100 includes one or more electrolysis reactors 10 configured to receive a flow of chloride-containing liquid and to generate chlorine-based disinfectant species through electrochemical oxidation of chloride ions. The reactors 10 may be arranged in parallel or series configurations within a production cabinet 70 and supplied with electrical power from a control cabinet 80. The generated chlorine species may be introduced directly into a wastewater stream to provide disinfection prior to discharge.

During operation, an aqueous solution containing chloride ions is introduced into the electrolysis reactor 10. An electrical potential is applied between one or more anodes and at least one cathode positioned within the reactor.

At the anode, chloride ions are oxidized to form chlorine according to the reaction:

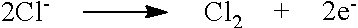

At the cathode, water is reduced to produce hydrogen gas and hydroxide ions according to the reaction:

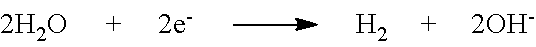

The chlorine generated at the anode dissolves in the surrounding aqueous solution and reacts with water to form hypochlorous acid and hydrochloric acid according to the equilibrium reaction:

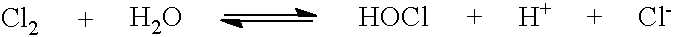

Hypochlorous acid may further dissociate to form hypochlorite ions depending on the pH of the solution. Collectively, hypochlorous acid and hypochlorite ions constitute the active chlorine disinfectant produced by the system.

As used herein, the term “chlorine disinfectant” refers collectively to chlorine species generated electrochemically from chloride-containing water, including but not limited to molecular chlorine (Cl₂), hypochlorous acid (HOCl), and hypochlorite ions (OCl⁻).

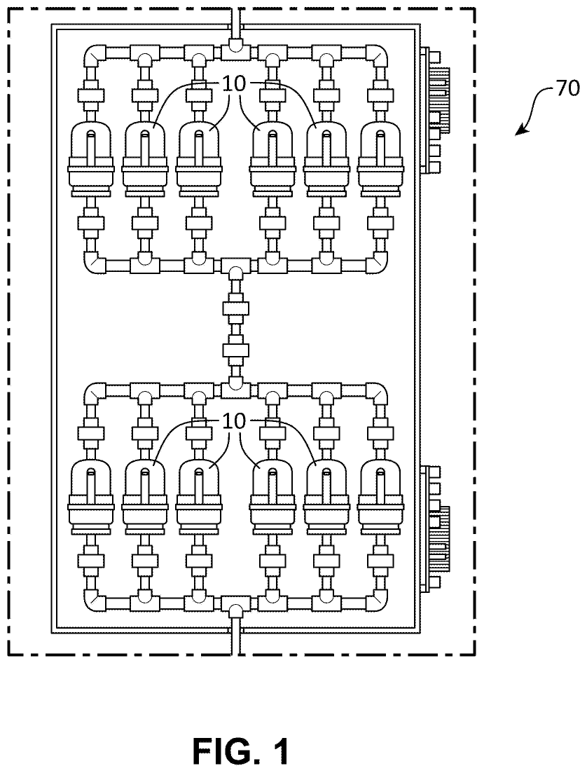

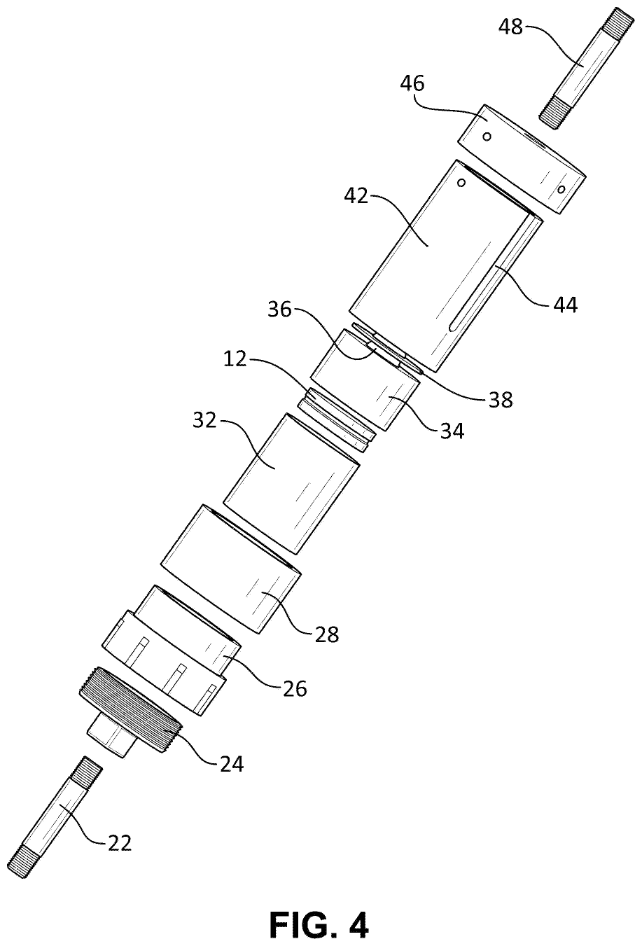

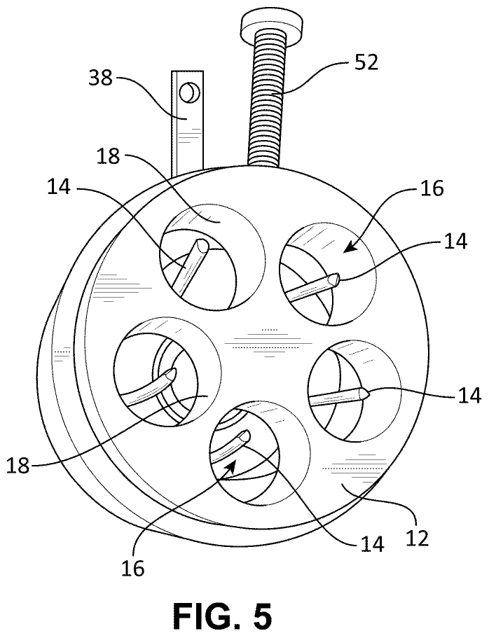

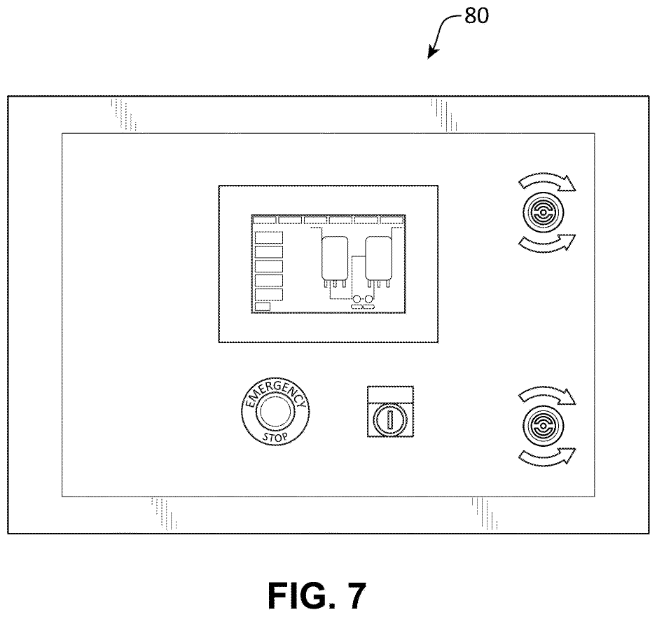

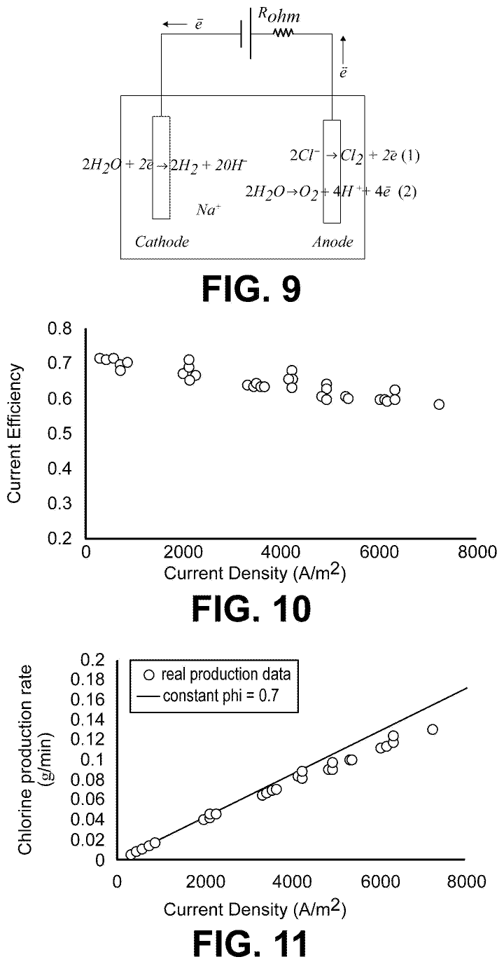

FIGS. 1-11 illustrate a system to generate chlorine-based disinfectant 100 for use in a method of on-site chlorine (HOCl) generation. The system 100 uses a membrane-less electrolysis reactor 10 to convert wastewater effluent and sodium chloride into on-demand chlorine disinfectant, which replaces the conventional use of a concentrated bleach tank to disinfect the wastewater effluent. The system is incorporated into a wastewater treatment system 1000, which likely deploys one or more sets of reactors 10 in a process of treating wastewater, the set of reactors 10 being contained within a production cabinet 70 and operated by a control cabinet 80.

Wastewater first comes into a tank box TB, and then passes through one or more rotating biological contactors RBC, which typically consists of a series of closely spaced, parallel discs mounted on a rotating shaft which is supported just above the surface of the wastewater and allows the wastewater to come into contact with a biological film in order to remove pollutants. From the rotating biological contactors RBC the wastewater moves on to one or more clarifiers C that are configured to permit heavier and larger particles to settle to the bottom of the clarifier where they subsequently move on to a sludge tank ST as the clarified wastewater continues through the system 1000. The clarified water is then sent to the reactors 10 in the production cabinet 70. In the embodiment shown, a cabinet 70 includes a plurality of reactors 10 operating in parallel. As the wastewater passes through a reactor chlorine is produced to disinfect the wastewater before it is sent to a disinfection tank DT and returned to the environment.

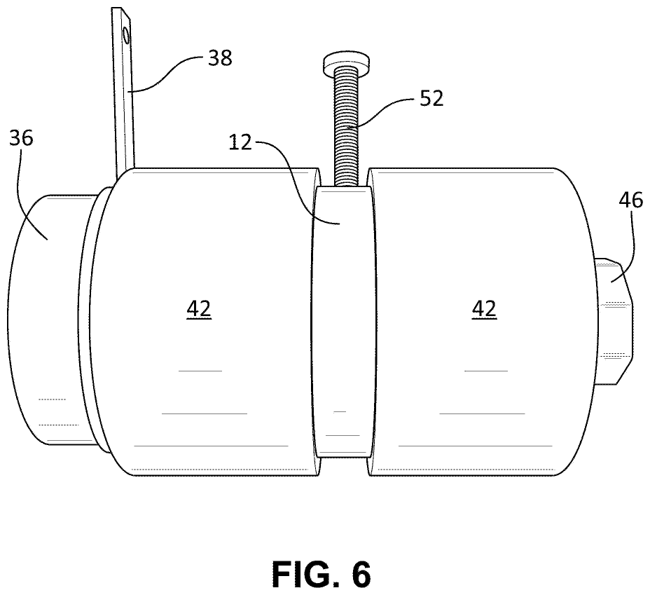

Each reactor 10 is a single-cell flow through reactor having a cathode 12 and anodes 14, where the cathode and anodes are best shown in FIG. 6. In the embodiment shown in the figures, the cathode 12 may comprise a conductive plate or disk having a plurality of through-holes or openings 16 extending between opposite surfaces of the cathode body. Each opening 16 defines an inner surface 18 that faces one or more anodes 14 positioned within the opening. The anodes are spaced from the inner surface of the opening to define an annular electrolysis region through which liquid flows during operation

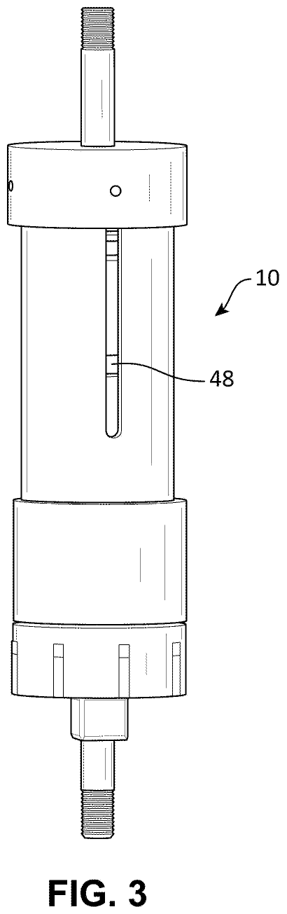

FIGS. 3-6 illustrate one complete embodiment of the reactor, though other configurations are also envisioned. In any embodiment, a housing surrounds the cathode and anodes, the housing being sealed for low-pressure water flow and having connectors on a top end and bottom end for connection to the wastewater recirculation unit, all likely to use conventional threaded fittings. In this specific embodiment, a lower pipe nipple 22 is the bottom end connector, which is connected to a pipe threaded plug 24, that works in conjunction with a pipe male cleanout 26, a pipe coupling 28, a lower flange 32, the cathode 12, an upper flange 7, pipe bushing 36, a Copper clad (PCB) Prototype Board Phenolic ring 38 for cathode electrical contact, a reactor casing 42 having a slot 44, a pipe cap 46, and an upper pipe nipple 48. Aside from electrical components, including the anodes 14, cathode 12, and contact ring 38, the components are made of a synthetic plastic polymer such as PVC.

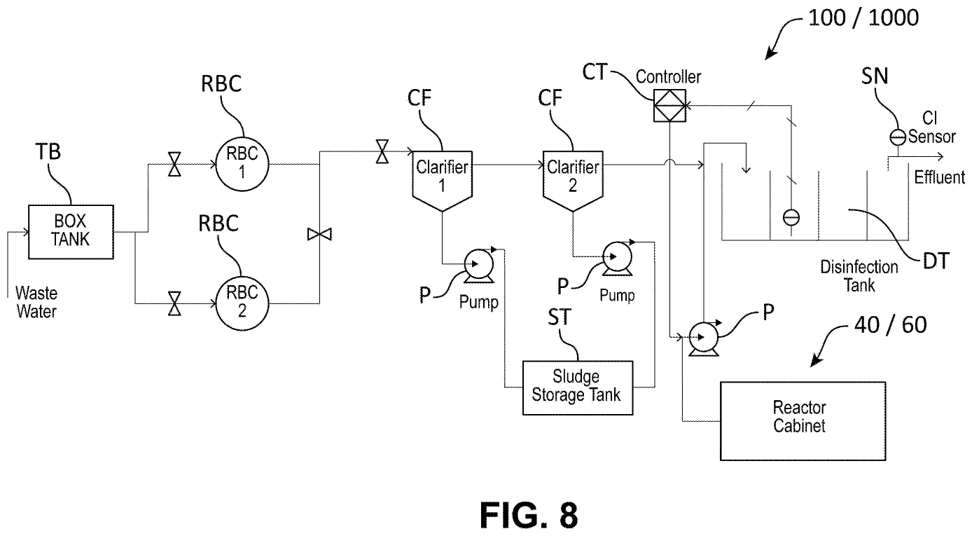

During operation, wastewater enters the reactor through the lower pipe nipple 22 and flows upward through the housing past the cathode 12 and anodes 14. The liquid flows through the openings 16 in the cathode and through the electrolysis regions surrounding the anodes, thereby serving as the electrolyte for the electrochemical reactions. Pumps P, illustrated in FIG. 8, move the wastewater through the system.

On one side of the reactor casing 42 is a slot 44 that reveals an opening 54 in the cathode 12 for insertion of a threaded fastener 52, which connects the cathode to an external circuit, i.e. a power supply (not shown). In use, electrons enter or leave the cathode through this fastener. As the cathode is a conductive metal, the electrons spread across the entire cathode body, such that the entire cathode surface becomes electrically active. At the anode, oxidation reactions occur and electrons release from the anode travel through the external circuit to the cathode. The fluid flows between the cathode and the anodes and ions travel through the fluid as a liquid electrolyte. Hydrogen gas generated at the cathode may be carried by the flowing liquid stream and released downstream of the reactor. In some embodiments the reactor housing or associated piping may include venting or gas separation components to safely remove accumulated gases. Having a fine thread on the fastener 52 increases the surface area and improves the electrical charge, for example, a 8-32NC screw is more effective than a 10-24NC screw.

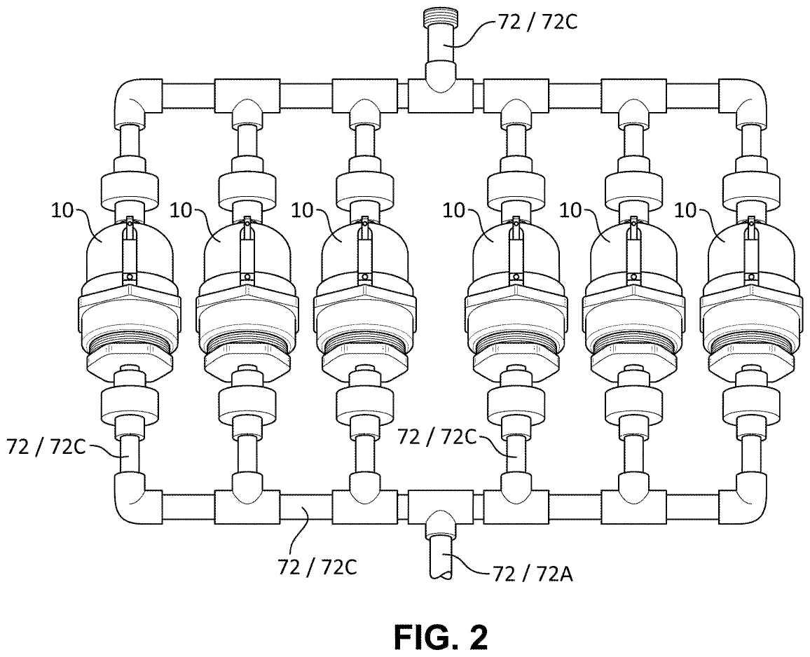

FIG. 2 illustrates a number of conventional conduits 72 that connect the reactors 10 to the system 1000, with 72A bringing fluid into the system 100, conduits 72B directing fluid into and out of the reactors, and 72C sending the treated fluid back in to the system 1000.

The exact construction of the reactor 10 may vary. For example, the reactors 10 may function well with a cathode 12 that has 5 openings 16, as shown in FIG. 6, and that either have 5 anodes 14 with one anode 14 positioned in each opening 16, or with 15 anodes 14 and where 3 anodes 14 are positioned in each opening 16 in the cathode 12.

Various materials may be suitable for the cathode 12, anodes 14, and housing. For example, in the embodiment shown the cathode is made of titanium, and the anodes are titanium rods that are coated with mixed metal oxides such as iridium and tantalum. For example Telpro Industries sells such anodes.

The reactor 10 and its components may also be made in various sizes. For example, in the embodiment shown the cathode 12 is a disk having a 1.75 inch diameter with a 0.5 inch thickness. The anode 14 is a rod having a 0.0875 inch diameter. In the 5 anode variant one anode was centered in each of the of openings, while in the 15 anode variant 3 anodes were positioned in each opening on a 0.2 inch diameter circle centered within the opening.

As to the differences between the 15-rod reactor and the 5-rod reactor, the 15-rod embodiment increases the surface area of the anode and decreases the distance between the anode and cathode, in this particular example from 5.5 mm to 3.0 mm, thereby reducing ohmic losses. At similar currents the 15-rod reactor reduced the power by 24% relative to the 5-rod reactor. This had the effect of improving current efficiency and reducing specific energy consumption. However, the 15-rod variant is more complex and thus in some instances the 5-rod, which as noted is quite effective, may be preferable.

In use, the amount of chlorine produced by the reactor 10 varies based on the inputs to the reactor 10. Hydrogen is produced at the cathode, and oxygen and chlorine may be produced at the anode, however, while oxygen is thermodynamically favored it is kinetically hindered relative to the chlorine reaction, which is dependent upon the anode material. The overall reaction assuming all chlorine production at the anode is defined as: 2H₂O+2NaCl→2NaOH+H₂+Cl₂

Electrons are generated at the anode and consumed at the cathode completing the current loop through the circuit. The constant, Ø is the current efficiency or charge yield for chlorine production. Non-chlorine production is represented by (1−Ø). Assuming the energy consumed by reaction is equivalent to the input energy, then: IV=Ø(jA)²R+ (1−Ø)(jA)²R (1)

Where (IV) is the supplied power, j is the current density, A is the surface area of the anode, and R is the overall resistance in the system which includes contributions from electrical contacts, electrode distance, and sodium chloride solution concentration.

Chlorine production scales with current (Faraday's Law, Eq. 2). The constant n=2 for the chlorine oxidation reaction. F is the Faraday constant.

$${r}_{{Cl}_{2}} = \frac{∅ j A}{n F} \qquad ( 2 )$$

The specific energy consumption for chlorine production is shown in Eq. 3, using the molecular weight of chlorine to convert moles to mass. This measurement is used to quantify reactor performance and depends on several different variables including resistance, current density and current efficiency. It is calculated by dividing the power by the chlorine production rate. The units in Eq. 3 are typically

$$\frac{kW \cdot hr}{{kg}_{{Cl}_{2}}} .$$

$$\frac{IV}{{r}_{{Cl}_{2}}} = ( \frac{j A R}{∅} ) ( \frac{2 F}{M} ) = ( \frac{{V}_{c e l l}}{∅} ) ( \frac{2 F}{M} ) \qquad ( 3 )$$

As shown in FIG. 10, as current density is increased through voltage increase, more energy is required to produce the same amount of chlorine. Electrolyzing 10 g/L sodium chloride solution requires more energy relative to 20 g/L sodium chloride because the internal resistance increases as sodium chloride concentration decreases. Other factors can contribute to high internal resistance including electrical contacts, electrode separation, and electrode materials.

Current efficiency also plays an important role in reactor performance, where current efficiency is also dependent on anode material selection. FIG. 10 illustrates the decrease in current efficiency with current density for the reactor 10 described herein, for sodium chloride concentrations of 20 g/L, specifically illustrating current efficiency drops from approximately 0.7 to 0.6 over the range of current densities. The effect of decreasing current efficiency on chlorine production rate is shown in FIG. 11. The solid line shows the expected production rate if the current efficiency remained constant as current density increased. The real chlorine production data deviates negatively from the line. This deviation increases specific energy consumption in chlorine production.

The control cabinet 80 may include a DC power supply, current regulators, sensors, and a programmable controller configured to regulate electrical current supplied to the reactors. In some embodiments, the controller may adjust current levels based on measured wastewater flow rate, chlorine production rate, or residual disinfectant concentration. The cabinet 80 is constructed and implemented using conventional techniques.

In some embodiments, the reactor may process liquid flow rates ranging from approximately 0.1 gallons per minute to 50 gallons per minute, depending on reactor size and the number of reactors operating in parallel. The chloride concentration of the liquid entering the reactor may range from approximately 1 g/L to 50 g/L sodium chloride, although higher or lower concentrations may also be used. In some embodiments, the reactor may operate at current densities ranging from approximately 50 A/m² to 3000 A/m². Cell voltages may range from approximately 2 V to 12 V, depending on electrode spacing and electrolyte conductivity.

Although the illustrated embodiment shows cylindrical rod anodes positioned within circular openings in a disk-shaped cathode, other electrode geometries may be used. For example, the cathode may comprise a plate, tube, mesh, or perforated structure, and the anodes may comprise rods, wires, plates, meshes, or other conductive elements. The number and arrangement of anodes relative to the cathode openings may also vary depending on desired current density and reactor performance.

The systems and methods described herein provide an efficient and scalable approach for generating chlorine-based disinfectants directly within wastewater streams. The membrane-less reactor design simplifies construction and maintenance while enabling integration with existing wastewater treatment infrastructure.

It is understood that the embodiments described herein are merely illustrative of the present invention. Variations in the construction of the reactor and method of use may be contemplated by one skilled in the art without limiting the intended scope of the invention herein disclosed.

1. A flow-through electrolysis reactor, comprising:
a cathode having a cathode body and one or more openings;
at least one anode positioned within each of the openings;
wherein, for each of the openings, the at least one anode is spaced from an inner surface of the opening to define an electrolysis region configured to receive a flow of a chloride-containing liquid;
and electrical connections configured to apply an electrical potential between the cathode and the at least one anode to generate a chlorine disinfectant in the chloride-containing liquid.

2. The reactor of claim 1, further comprising a housing surrounding the cathode and the at least one anode, the housing being sealed for low-pressure water flow and including a first connector and a second connector for fluid connection.

3. The reactor of claim 1, wherein the cathode comprises a conductive disk and the openings comprise through-holes in the conductive disk.

4. The reactor of claim 1, wherein the at least one anode comprises an elongated rod positioned within a corresponding opening.

5. The reactor of claim 1, wherein each opening contains a plurality of anodes.

6. The reactor of claim 5, wherein each opening contains three anodes.

7. The reactor of claim 1, wherein the cathode comprises titanium.

8. The reactor of claim 1, wherein the at least one anode comprises a titanium rod coated with mixed metal oxides including iridium and tantalum.

9. A modular disinfectant generation system, comprising:
a plurality of flow-through electrolysis reactors disposed in the production cabinet, each reactor comprising (i) a cathode having a plurality of openings extending through a cathode body and (ii) at least one anode positioned within each opening and spaced from an inner surface of the opening to define an electrolysis region;
fluid conduits configured to deliver a chloride-containing liquid to the plurality of reactors; and
a power supply configured to provide electrical current to the plurality of reactors to generate a chlorine disinfectant in the chloride-containing liquid.

10. The system of claim 9, wherein the plurality of reactors are arranged in parallel.

11. The system of claim 10, further comprising a control cabinet including a controller configured to regulate current supplied to the plurality of reactors based on at least one operational condition.

12. The system of claim 11, wherein the at least one operational condition comprises wastewater flow rate.

13. The system of claim 11, wherein the at least one operational condition comprises residual disinfectant concentration.

14. The system of claim 10, wherein a disinfectant generation capacity of the system is scalable by increasing or decreasing a number of the plurality of reactors installed within the production cabinet

15. A method for disinfecting wastewater effluent in a wastewater treatment facility, comprising:
directing a stream of wastewater effluent containing dissolved chloride ions through at least one flow-through electrolysis reactor, the electrolysis reactor comprising a cathode having a cathode body with one or more openings extending through the cathode body and at least one anode positioned within each of the openings and spaced from an inner surface of the opening to define an electrolysis region;
flowing the wastewater effluent through the electrolysis region such that the wastewater effluent functions as an electrolyte between the cathode and the at least one anode;
applying an electrical potential between the cathode and the at least one anode to oxidize chloride ions in the wastewater effluent and generate a chlorine disinfectant in the wastewater effluent; and
allowing the generated chlorine disinfectant to disinfect the wastewater effluent prior to discharge;
discharging the disinfected wastewater effluent from the wastewater treatment facility.

16. The method of claim 15, wherein the one or more flow-through electrolysis reactors comprise a plurality of reactors arranged in parallel in a production cabinet.

17. The method of claim 15, further comprising regulating electrical current supplied to the one or more flow-through electrolysis reactors using a controller based on at least one of wastewater flow rate, chlorine production rate, or residual disinfectant concentration.

18. The method of claim 15, wherein each electrolysis reactor comprises a tubular housing and the wastewater effluent flows upward through the tubular housing past the cathode and the at least one anode.
